(19) United States
(12) Patent Application Publication
(10) Pub. No.: US 2004/0171508 A1
(43) Pub. Date: Sep. 2, 2004

(54) Thickened aqueous compositions

(76) Inventor: Daniele Fregonese, Ludwigshafen (DE)

Correspondence Address: ANDREW N. PARFOMAK, NORRIS, MCLAUGHLIN & MARCUS, 220 EAST 42ND STREET, 30TH FLOOR, NEW YORK, NY, 10017, US

(21) Appl. No.: 10/478,240

(22) PCT Filed: May 23, 2002
(86) PCT No.: PCT/GB02/02419

(30) Foreign Application Priority Data
May 25, 2001 (GB) 0112764.6

(51) Int. Cl. C11D 7/18

(52) U.S. Cl. 510/375; 510/463

(57) ABSTRACT

The invention relates to a thickened aqueous composition comprising a xanthan gum having an acetate content of less than 6.2% wt of the gum but greater than 0.1 % wt, and an oxidising agent dissolved into the aqueous composition.

The invention relates to thickened aqueous compositions which contain xanthan gum and an oxidising agent dissolved into the aqueous composition.

Bleach precursor compounds based upon peroxygen systems are currently being used in several household laundry detergents and colour-safe laundry bleaches. However, many of the products are basedupon the peroxygen system being a solid, either a dry solid or a liquid suspension of solid, that release the hydrogen peroxide bleach upon dissolution in water. These forms circumvent the significant instability of hydrogen peroxide in neutral or alkaline aqueous solutions.

Aqueous carpet cleaning compositions containing hydrogen peroxide have also been disclosed in the prior art. These cleaning compositions typically use high amounts of solvents to stabilise the hydrogen peroxide. For example, U.S. Pat. No. 5,252,243 to Charles Minns discloses cleaning compositions containing about 15% to 20% by weight alcohol such as isopropanol (“IPA”) and from about 3% to about 12.5% by weight of hydrogen peroxide.

Thickening systems for liquids are known, based upon polysaccharides, clays or surfactants. We have found that certain types of xanthan gums can help form thickened aqueous compositions into which an oxidising agent, such as a bleaching agent, preferably hydrogen peroxide, can be dissolved. Such compositions are highly stable for extended periods of time.

EP0368575, ICI, discloses the suspension of a bleach precursor compound, sodium perborate tetrahydrate, into aqueous liquids, which are thickened with xanthan gum.

Xanthan gum is an acidic, anionic, extracellular heterpolysaccharide, secreted from X.campestris. The polysaccharide is thought to act as a protective slime, essential for the pathogenecity of the micro-organism towards its plant host (Rutabaga plant) by blocking fluid flow through the xylem.

The primary structure of Xanthan gum is a (1→4)-linked-β-D-glucan cellulose backbone, with trisaccharide side chains attached at C-3 to alternate glucose residues. However, other workers have postulated that the trisaccharide side chains are linked at O-3 of alternate residues, to give an overall repeating pentasaccharide sequence; such repeating sequences are common to extracellular bacterial polysaccharides. The trisaccharide side chain consists of two D-mannose residues and on D-glucuronic acid residue occurring as mixed K⁺, Na⁺ and Ca⁺ salts in the following sequence;

β-D-man-p(1→4)-β-D-GlcpA-(1→2)-α-D-manp-1→

However, this sequence may contain varying amounts of O-acetyl and pyruvic acetal groups to give structural heterogeneity. Sophisticated techniques of methylation analysis and a specific scheme for polysaccharides containing uronic acid residues have concluded that the terminal β-D-glucuronic acid residue is (1→4)-linked to the non-terminal α-D-mannose residue. These β and α linked mannose residues are pyruvated and acetylated respectively. The acetic acid residues are O-6 linked to the non-terminal α-D-mannose residue, and the pyuvic acid is acetal linked through O-4 and O-6 to the terminal β-D-mannose residue, which has been established as the S-configuration. Both these constituents occur in non-stoichiometric amounts. It is thought that a half to a third of the terminal β-D-mannose residues bear a pyruvic acid group depending on the culture conditions. These side chains are proposed to modify the normal backbone geometry, leading to a helical structure with 5-fold symmetry (secondary structure). Through the association of Xanthan molecules, it is thought that a quaternary structure arises through the charged trisaccharide side chains. The above description is the generally accepted primary structure for Xanthan gum.

Xanthan gum is produced by bacterial fermentation and was the first polysaccharide produced on a large scale using X.campestris. Such a technique offers the advantage of reproducible physical and chemical properties, with a stable cost and supply. Nevertheless, unlike other microbial extracellular polysaccharides, the composition of the polymer varies with the Xanthomonas strain and culture conditions and in the presence or absence of pyruvate and/or acetate substituents.

The polysaccharide forms highly viscous solutions at low polymer concentrations, which are atypically insensitive to a wide range of salt concentration, pH and temperature. In addition to this, Xanthan solutions exhibit strong shear thinning behaviour showing non-Newtonian behaviour, a measurable yield stress from about 1% polymer concentration, emulsion stabilising and particle suspending abilities, which are all indicative of intermolecular associations.

This natural polysaccharide is widely used in the food industry and to a lesser extent the pharmaceutical industry. Most of the commercial Xanthan samples contain a variable amount of Na⁺, K⁺, Ca²⁺ salts, and approximately 30-40% pyruvate content with 60-70% acetate content (although this is subject to variability).

It has been found that Xanthan gum is partially acetylated (4.7%), which corresponded to one residue per pentasaccharide repeating unit. Uronic acid degradation has been used to locate the distribution of the acetate groups, and it has been found that they are linked to 0-6 of the D-mannose residues in the main chain.

The acetate groups are located close to the centre of the Xanthan helix, and their role has been postulated in the involvement of intermolecular interactions. The acetate groups are also known to affect the transition temperature of Xanthan gum. For example, it has been shown that deacetylation causes a decrease in the transition temperature. The acetyl groups have a stabilising effect on the ordered structure, hence the increase in the transition temperature. The reason for the stabilising effect of the acetate groups is at present unknown, however it has been postulated that a possible reason for the stabilising effect, could be due to apolar interactions between acetyl methyl groups, or that the acetate groups represent the hydrogen bond acceptors which are responsible for stabilising the molecule. A genetically modified Xanthan sample (polytetramer) which contains no acetate groups also produces results similar to studies carried out for deacetylated and depyruvated Xanthan samples.

It is believed that oxidising agents, such as hydrogen peroxide, will interfere with the acetate groups on the xanthan gum and will prevent the thickening of aqueous solutions. To this end special, and more expensive, deacetylated xanthan gums are produced for such purposes such as Kelzan AST from CP Kelco, which are stated to contain no detectable acetates. We have found that oxidising agents, such as waters-soluble bleaches, preferably hydrogen peroxide or a hypohalite bleach, can be dissolved into an aqueous composition thickened with a xanthan gum having an acetate content of less than 6.2% wt, ideally less than 6.1, 6.0, 5.9, 5.8, 5.7, 5.6, 5.5, 5.4, 5.3, 5.2, 5.1, 5.0, 4.9, 4.8, 4.7, 4.6, 4.5, 4.4, 4.3, 4.2, 4.1, 4.0, 3.9, 3.8, 3.7, 3.6, 3.5, 3.4, 3.3, 3.2, 3.1, 3.0, 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, 1.1, 1.0, 0.9, 0.8, 0.7, 0.6, 0.5, 0.4, 0.3, 0.2, 0.1% wt of the xanthan gum. The acetate content is preferably higher than 0.1% wt, 0.5% wt, 0.8% wt or 1.2% wt of the xanthan gum.

We present as a feature of the invention a thickened aqueous composition comprising a xanthan gum having an acetate content of less than 6.2% wt of the gum but greater than 0.1% wt, and an oxidising agent dissolved into the aqueous composition.

We present as further feature of the invention a method of removing stains from a fabric which method comprises contacting the fabric with a wash liquor which comprises a thickened aqueous composition as defined herein.

The method for measuring the amount of acetate groups in the xanthan gum is described below in detail. Briefly the acetate content is measure by treating a 1 ml aqueous solution of xanthan gum (5 mg ml⁻¹) with 1 ml of potassium hydroxide (0.2M) and measuring the acetate content by HPLC, for further details see below.

The hydrogen peroxide is preferably stabilised for temperature, pH and the presence of metal ions. If stabilised hydrogen peroxide is not available from the commercial supplier, hydrogen peroxide stabilisers may be added.

Suitable commercial stabilisers for temperature, pH and the presence of metal ions useful in the present invention. These stabilisers include salts of citric acid, radical scavengers, such as BHT, phosphonate stabilisers such as, diethylenetriaminepenta (methylene phosphonic acid) and its corresponding pentasodium salt, available under the trade names Dequest 2060 and Dequest 2066, DTPMP and DTPMA (Dequest 2010) respectively, from Monsanto Chemical Co. Preferably, the stabiliser is Dequest 2066. The amount of stabiliser needed depends on the grade of hydrogen peroxide used.

The amount of oxidising agent, preferably hydrogen peroxide, in the composition is between 0.1 to 15% wt, ideally, 3 to 10% wt.

Organic solvents may optionally be added for use in the present invention and can be any water-miscible organic solvent. Suitable solvents include C3-C12 alkyl glycol ethers and C1-C4 alcohols, such as methanol, ethanol and isopropanol . More preferably, the solvent is selected from the group consisting of EGBE, ethylene glycol hexyl ether (“EGHE”) and mixtures thereof. The solvent is typically present in an amount from about 0.5% wt to about 4.0% wt, preferably from about 0.75% wt to about 2.5% wt, and most preferably from about 1.0% wt to about 2.0% wt of the composition. EGBE is available from Union Carbide under the trade name Butyl Cellosolve. EGHE is available under the trade name Hexyl Cellosolve from Union Carbide. Preferably the composition contains less than 5% wt, ideally less than 2% wt of a water-miscible organic solvent.

The pH, as defined in the present context, is measured in the neat compositions at 20° C. For optimum stability of these compositions, the neat pH, measured in the above-mentioned conditions, must be in the range of from 2 to 5, ideally from 4 to 4.4. The pH of these compositions herein can be regulated by the addition of a Bronsted acid or base.

Xanthan gum is a water-soluble polymer. It is soluble in hot and cold water, as well as being stable in acidic and alkaline conditions (pH1.5-13). The solubility of Xanthan allows highly viscous solutions at low concentrations, i.e., a 1% solution has a viscosity of 800-1000 cps (60 rpm/LVF Brookfield viscometer). Preferred viscosities of solutions generated are 30 to 300 cps, preferably 50 to 300 cps, ideally 100 to 250 cps.

Aqueous solutions containing more than 0.75% wt polymer have a yield point, which implies that Xanthan will remain solid until a minimum shear force is reached, indicative of the gel strength. The viscosity of Xanthan increases as the shear rate decreases, and solutions return to their original viscosity once the shear force is removed, i.e. the molecular associations reform. Preferred concentrations of xanthan gum are less than 0.75% wt, ideally less than 0.5% wt, preferably less than 0.3% wt, and especially less than 0.2% wt.

Acetate Group Analysis

Acetic acid (AJAX) was purified by distillation. Xanthan samples were derived from Keltrol (Kelco Division of Merck & Co. Inc, USA). Standard curves for each acid were prepared.

HPLC Analysis

HPLC was carried out on a system consisting of a Rheodyne 7125 injector, M6000 pum (Waters), Varichrome u.v. -visible detector (Varian) set at 210 nm, and a Bio-Rad HPX-87H column (300×7.8 mm) fitted with an ion exclusion precolumn cartridge (Bio-Rad.)

Initial work was recorded on a National VP-6513A chart recorder. Quantitative analyses were carried out on a 3390-A Integrator (Hewlett-Packard). The eluent was 8 mm sulphuric acid, at a flow rate of 0.6 ml min⁻¹. Column temperature was maintained at 35° C. by an Eldex column heater.

Sample preparation

Polysaccharide was dissolved in water to a concentration of 5 mg ml⁻¹, by stirring overnight at room temperature and then stirring at 90° for 1h.

The exact concentration was determined by the phenol/sulphuric acid procedure (Dubois et al., J.Amer.Chem.Soc.(1956) 28, 350-).

Acetate

To polysaccharide solution (1 ml) was added potassium hydroxide solution (0.2M, 1 ml). The sample was flushed with nitrogen, sealed and held at 45° C. for 6h. The solution was made acidic with phoshoric acid, and diluted to exactly 3 ml with water, filtered and injected. Elution time was 15.8 min.

### EXAMPLES

Opaque

| | |
|---|---|
| Hydrogen Peroxide | 6.5000 |
| Phosphonate | 0.1200 |
| Nonionic | 7.0000 |
| Xanthan Gum | 0.1200 |
| Dye | 0.0009 |
| Perfume | 0.2000 |
| Opacifier | 0.0800 |
| Water | 85.9791 |
| | 100.0000 |

Transparent

| | |
|---|---|
| Hydrogen Peroxide | 6.5000 |
| Phosphonate | 0.1200 |
| Nonionic | 7.0000 |
| Xanthan Gum | 0.1200 |
| Dye | 0.0006 |
| Perfume | 0.2000 |
| Water | 86.0594 |
| | 100.0000 |

Materials Used

hydrogen peroxide (50% concentration, DS CP type) is supplied from Solvay,

phosphonate used in HEDP (Sequion 10 H 60 from Bozzetto or Dequest 2010 from MONSANTO or Briquest ADPS 60 A from Albright and Wilson),

nonionic is an oxoalcohol C13-C15 with 8 EO (Lutensol AO 8 BASF),

Xanthan Gum (supplied from ADM Ingredients Italia)

The above formulations gave a product which is viscous and the viscosity is retained over time. Also, the level of hydrogen peroxide is constant over time (e.g. the product is stable, as there is no sign of chemical oxidation/reaction).

Stability Data

Opaque

| Initial viscosity: | 160 +/− 30 cps |
|---|---|
| | (measured with a |
| | Brookfield RVF, |
| | spindle 1, 10 rpm |
| | at 20° C.) |
| Viscosity after 1.5 months stored at 20° C.: | 160 +/− 30 cps |
| | (same instrument |
| | used) |
| Viscosity after 1.5 months stored at 40° C. | 155 +/− 30 cps |
| | (same instrument |
| | used) |
| Initial Level of Hydrogen Peroxide: | 6.50% |
| Hydrogen Peroxide 1.5 months stored at 40° C.: | 6.50% |

Transparent

| Initial viscosity: | 210 +/− 30 cps |
|---|---|
| | (measured with a |
| | Brookfield RVF, |
| | spindle 1, 10 rpm |
| | at 20° C.) |
| Viscosity after 1.5 months stored at 20° C.: | 210 +/− 30 cps |
| | (same instrument |
| | used) |
| Viscosity after 1.5 months stored at 40° C. | 190 +/− 30 cps |
| Initial Level of Hydrogen Peroxide: | 6.50% |
| Hydrogen Peroxide 1.5 months stored at 40° C.: | 6.50% |

1. A thickened aqueous composition comprising a xanthan gum having an acetate content of less than 6.2% wt of the gum but greater than 0.1% wt, and an oxidising agent dissolved into the aqueous composition.

2. A thickened aqueous composition as claimed in claim 1 wherein the oxidising agent is a water-soluble bleach.

3. A thickened aqueous composition as claimed in claim 2 wherein the water-soluble bleach is hydrogen peroxide or a hypohalite.

4. A thickened aqueous composition as claimed in claim 3 which additionally comprises a stabilising agent, preferably a phosphonate.

5. A thickened aqueous composition as claimed in any claim from 1 to 4 wherein the xanthan gum is present at up to 7.5% wt.

6. A thickened aqueous composition as claimed in claim 6 wherein the water-soluble bleach is present at between 0.1 to 15% wt.

7. A thickened aqueous composition as claimed in preceding claim which additionally comprises a surfactant.

8. A thickened aqueous composition as claimed in preceding claim which contains less than 5% wt, ideally less than 2% wt of a water-miscible organic solvent.

9. A method of removing stains from a fabric which method comprises contacting the fabric with a wash liquor which comprises a thickened aqueous composition as defined in any claim from 1 to 8.
